(19) United States
(12) Patent Application Publication
(10) Pub. No.: US 2013/0297741 A1
(43) Pub. Date: Nov. 7, 2013

(54) APPARATUS AND METHOD FOR HANDLING INTERACTIVE MEDIA CONTENT REQUESTS USING MULTIPLE MEDIA MANAGERS

(71) Applicant: George Stoikos, Serres (GR)

(72) Inventor: George Stoikos, Serres (GR)

(73) Assignee: AKOO INTERNATIONAL, INC., Rosemont, IL (US)

(21) Appl. No.: 13/463,969

(22) Filed: May 4, 2012

(51) Int. Cl. G06F 15/16

(52) U.S. Cl. 709/219

(57) ABSTRACT

A digital media selection and playback system includes a master media manager controller disposed in communication with at least one location media server which is disposed communication with at least one audio-visual device. At least one or a plurality of virtual mobile media manager controllers are disposed in data communication with the master controller and are coupled to one or more location media servers, each of which communicates with one or more audio-visual devices. One or more location media servers embodied in a computer readable mediums in computing devices which communicate via streaming A/V streams to different smart audio-visual devices. A user request for a selected media to be played on a selected audio visual device is routed through the mobile media manager controller and a selected virtual location media server to the selected audio visual device.

### BACKGROUND

The present invention relates, in general, to audio/visual content delivery and broadcast systems and, specifically, to the selection of specific content or media for output on a selected audio/visual device.

Audio/video media content selection and delivery systems come in many forms. Generally speaking, a user via a computer, mobile communication device, etc., can access a source of audio/video content, and then select the desired content for delivery to a specific audio/video device, such as a jukebox system in a bar or restaurant, a computer monitor, the user's mobile device, etc.

For example, a typical audio/video selection and delivery system as shown in Applicants' prior U.S. Pat. Nos. 7,647,613 and 7,797,719.

Applicants' system utilizes a central music server coupled to media content storage, such as music, videos and combinations thereof. A central mobile media manager server is interposed between a wireless communication system, such as the Internet receiving media requests from user devices, such as personal computers, tablet computers, mobile communication devices, such as cellular telephones, etc. and controls the management, selection and output of such selected media content through the central music server to an audio/video display device selected by the user.

The mobile media manager server communicates with a location media server at the display cite, such as digital jukebox, etc. A location media server, at the bar or restaurant, controls the display of the selected media content on a selected one of one or more audio/video devices in the location, such as one or more display screen monitors in a bar or restaurant. The location media server, in conjunction with the mobile media management server, can also be employed to direct selected media content to one specific audio/video device from one user and other selected media content from other users to other audio/video devices in the same location.

However, Applicants' prior apparatus and method for interactive content requests is capable of supporting a limited number of audio/video units through a limited number of location media servers. It would be desirable to provide a method and apparatus for expanding Applicants' mobile media manager apparatus and method to support multiple audio/video units which may be located in the same or many different physical locations.

Applicants' prior patented system was also directed to audio-visual devices which were typically just monitors or display screens for visually displaying the audio-visual media selected by a user. A whole new class of audio-visual devices is currently in use which include computer processors, such as so called smart A/Vs, such as Internet televisions, game consoles and, in general, tablet computers, smart phones as well as PC's including laptop and desktop computers.

It would be desirable to provide a media request selection method and apparatus which enables the user to request a specific digital media to be played at a specific A/V device where the selected A/V device may have additional computer processing capabilities for media storage, time of day playing, playback and other features.

### SUMMARY

A method for digital content selection and play comprises the steps of:

receiving a user request by a master media manager controller (MMM) requesting a specific digital media for play on a specific audio-visual playback device, providing, at least one virtual MMM residing in a computer readable medium of a computing device disposed in data communication with the master MMM, at least one location media server (LMS) in communication with the at least one virtual MMM, providing at least one audio-visual device in communication with the at least one LMS, which can be at least one virtual LMS accessing by the master media manager controller; a digital store of digital media content, and transmitting the identified digital media by the master MMM through the at least one virtual MMM and the at least one location media server to the selected audio-visual device for play of the identified digital media by the selected audio-visual device.

A plurality of virtual MMMs may be provided in communication with the master MMM along with a plurality of location media servers, with at least one location media server disposed in communication with each virtual MMM, and at least one audio-visual device disposed in communication with each location media server.

The method may further comprise the step of disposing the plurality of virtual MMM's and the master MMM in communication with each other such that each one of the master MMM and the virtual MMM's able to access the digital media store.

In one aspect, the plurality of virtual MMM and the master MMM are disposed in a mesh network with each other. In one aspect, each of the master MMM and the virtual MMMS are disposed for receiving a user request.

In one aspect, the one of the master MMM and the virtual MMMS that receives an incoming user request determines if the receiving MMM can service the user request. If yes, the receiving MMM determines the availability of one of the location media servers disposed in communication with the receiving MMM, and forwards the digital media in the user request to the selected location media server.

In the method, if the receiving MMM cannot service the incoming user request, the master MMM ranks all of the available virtual MMMS in descending rank according to ranking parameters, forwards the incoming user request to the first ranked MMM determines if the first ranked MMM can service the incoming user request and, if yes, the receiving MMM forwarding the incoming user request to the first ranked MMM.

In the method, of the first ranked MMM cannot service the incoming user request, the first ranked MMM is removed from the top of the ranking, and receiving MMM forwards the incoming request to the ranked MMM.

A streaming audio-video server can be coupled in communication with the media store, the master mobile media controller, and any of the virtual media manager controllers to convert a selected media in a user request to a streaming audio-video format, which is then transferred by the streaming audio-video server through the mobile media controllers to the specified local media controllers and A/V devices.

The method further provides a plurality of virtual location media servers and at least one audio-visual device disposed in communication with each virtual location media server.

In the method, the one of virtual LMSs that receives an incoming user request determines if it can service the user request. If yes, the receiving LMS forwards the digital media content specified in the user request to the selected A/V device.

An apparatus for digital content selection of play comprising at least one audio-visual playback device capable of playing audio-visual media, the audio-visual playback device having a distinct identifier, a location media server coupled to the at least one audio-visual playback device for transferring digital media content to a selected at least one audio-visual playback device, a master media manager controller configured for receiving a user request from a user interface separate from the at least one audio-visual playback device, the user request identifying a distinct audio-visual media content and the distinct identifier of the at least one audio-visual playback device, at least one virtual media manager controller embodied in a computer executable medium in a computing device coupled to the master media manager controller, and the at least one virtual media manager controller coupled by a first communication path with the at least one location media server.

A streaming audio-video server can be coupled in communication with the media store and the master mobile media controller, to convert a selected media in a user request to a streaming audio-video format, which is then transferred by the streaming audio-video server through the mobile media controllers or directly to the specified virtual location media server and A/V devices.

### BRIEF DESCRIPTION OF THE DRAWING

The various features, advantages and other uses of the present invention will become more apparent by referring to the following detailed description and drawing in which:

FIG. 1 is a block diagram of one aspect of an apparatus for handling interactive content requests;

FIG. 2 is a block diagram of the mobile media manager (MMM) and virtual mobile media network shown in FIG. 1;

FIG. 3 is a detailed block diagram of the apparatus shown in FIG. 1;

FIG. 4 is a detailed block diagram of the mobile media manager shown in FIG. 1;

FIG. 5 is a flow diagram depicting a method for interactive content request;

FIG. 6 is a block diagram of another aspect of an apparatus for handling interactive content request;

FIG. 7 is a block diagram of another aspect of the apparatus;

FIG. 8 is a block diagram of an apparatus for handling interactive content requests;

FIG. 9 is a flow chart of one aspect of a method of operation of the apparatus shown in FIG. 8; and

FIG. 10 is a flow chart of another aspect of a method of operation of the apparatus shown in FIG. 8; and

FIG. 11 is a block diagram of another aspect of an apparatus for handling interactive content requests using multiple virtual mobile media manager controllers and multiple location media servers.

### DETAILED DESCRIPTION

An interactive media request system in a communication network is disclosed for selecting content, such as songs and/or videos, from user requests from a mobile communication device for output by an audio-visual playback device.

The term “audio-visual” as referred to herein to encompass audio data, such as music, spoken words, etc., visual data, such as movies, video games, and other visual images, including text, and combinations of audio and visual material simultaneously output to an audio-visual playback device. Thus, it will be understood that although music and music identification data are referred to hereafter, it will be understood that this is by way of example only.

Further, it will be understood that the use of the term digital media will encompass both audio and/or visual data as well as audio and/or visual data identification, such as author name, title, length of play, type of media, etc.

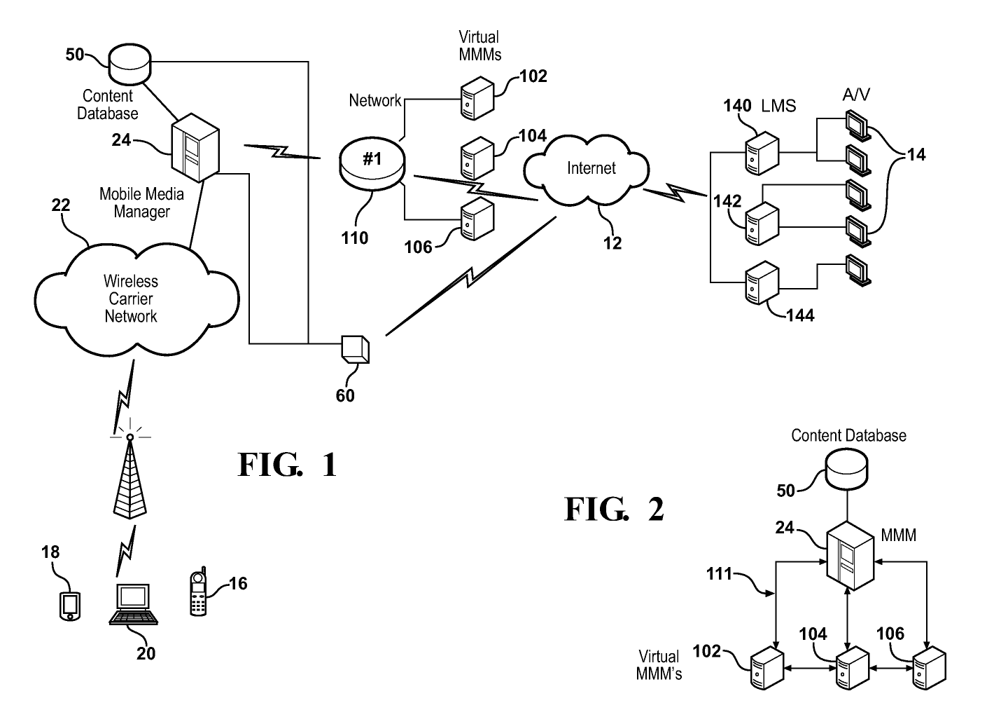

In one aspect shown in FIG. 1, a central management system manages a communication link to mobile stations in a media content network and translates packets in the payloads of SMS, MMS or Internet messages containing specific content selections created by a mobile user located remote from the playback devices. A central Mobile Media Manager (MMM) 24 implemented as a feature of communication link 22, such as a carrier network, which may be implemented as a Short-Message-Service-Center (SMSC) 22 and Mobile-Multimedia-Service-Environment (MMSE) or an Internet network, manages concurrent mobile-originating transmissions representing mobile user selected content or media, such as song selections, designated for broad case from one of a plurality of A/V devices.

At least a portion of the carrier network 22 may include wireless communication. The central MMM 24 addresses a media content database 50 via HTTP, for example, that maintains a master set of compressed digital data or media representing a plurality of songs, song associated graphics, song identity information, videos and audio/video (A/V) venue location identification codes, for example. The MMM 24 receives mobile selection information from the carrier network 22 and polls the database 50 to obtain an updated list of registered audio/visual devices 14, to determine content availability from a list of content or music residing on the database 50 and/or the A/V devices 14, and to check the validity of the user request.

Specific content selections initiated by a mobile user 16, 18, 20 including content event or song identity, venue location register and service priority queuing to a specific A/V device 14, received at the central MMM 24 to provide audio or video output in the service, venue or A/V device 14 where the mobile user initiated the selection. The MMM 24 interfacing the carrier network 22 and the A/V network operates on a scheduled peer session interval to authenticate users, determine the value of the billing event and handle submission of user requests. The MMM 24 differentiates the value of the network carrier requests to the billing entity. The MMM 24 communicates to the core network carrier 22 whether a mobile user, i.e., wireless carrier, SMSC, etc., should be billed only after the MMM 24 has verified that a corresponding A/V device 14 is operating, the MMM 24 has verified that the master or the subset of the master set of digital media is available, and the MMM 24 has forwarded the user request designated as a Standard or Priority request to be placed in the network 10 queue.

In FIG. 1, an A/V network 100 is illustrated, by example, as including a master mobile media manager controller (MMM) 24 having a host processor which communicates via HTTP or other data transmission formats through a wireless communication system, such as the Internet 12, hardline, etc., to at least one or a plurality of digital audio-visual playback devices 14, such as monitors, digital jukeboxes, mobile telephone and tablet computer display screens, smart televisions, etc. The communication format to each A/V device 14 can be via any transmission protocol, such as ADSL, cable modem, WCDMA, UMTS, or LMDS or other data communication protocols.

According to this aspect, a mobile communication device or user interface, typically a mobile wireless communication device, such as a cellular telephone 16, a PDA 18, or a computer 20, as non-limiting examples only, communicates with the communication network 22. The communication link or network 22 may be any type of communication provider either wireless or not, such as, but not limited to, WiFi, Internet, direct cable connection, Ethernet, GSM, GPRS, UMTS, Edge, Token ring etc. Such a network 22 may have as a subset, a Short Message Service Center (SMSC) adapted for short text messaging, an Internet protocol having displayable drop down menus allowing user input selections, or a multimedia service (MMS) providing audio and graphic data.

Although the following example of a wireless content request pertains to a short message service using an SMSC subset of the wireless carrier network 22, it will be understood that similar data input protocols or media selection, such as through drop down menus, may also be employed.

An appropriate SMS address, such as 1414 for example, is entered by the user through the communication device 16, 18, or 20 to identify the MMM 24 service. Text messages formed of UNICODE or ASCII characters are then input by a user through the user interface 16, 18, or 20 to identify the digital media selection and other related play features, such as premium play, immediate play, etc. For example, a text message of S AB123 can be input by a user through the communication device 16, 18 or 20. The first character, labels S, by example only, is the type of media content. By example only S identifies a song. V would identify a video. PS would identify a priority play of a selected song. PV would identify a priority play of a video. The characters AB identify the location of the local jukebox 14. The alphanumeric characters 123 identify a particular media selection, such as a particular song. This information is obtainable from a list provided to the user at the local jukebox 14 venue.

These signals are transmitted to the SMSC where the user ID is validated. The location of the A/V playback device 14, media selection, and play feature data are transmitted from the SMSC to the MMM 24 by hard wire and/or wireless communication or combinations of both. The MMM 24 receives the selection information from the SMSC and communicates with the database 50 to determine the availability of the selected content and the selected A/V devices 14. When the MMM 24 has verified the corresponding A/V device 14 is operating and available to play the selected digital media, the MMM 24 sends a signal to the SMSC to bill the user for the SMS message including any premium play billing. The SMSC may then request a third party, such as, but not limited to, a bank, a credit card company, a mobile operator, etc., to debit the user account for the amount of the services procured. Other methods of payment may include m-wallet (mobile wallet), prepaid cards etc.

The MMM 24 can also communicate directly with a bank, credit card company or mobile operator to perform billing procedures without directly contacting the SMSC.

The user's communication device, namely, the user's mobile telephone 16, PDA 18 or even the user's desktop or laptop computer 20 can be provided with an application (hereafter “app”) which replaces the functionality of the SMS message sent by the user to the MMM 24.

The user can open the app and then press or click a button in the app which corresponds to a selection of a song or video to play at a particular location. The app creates a message using established protocols, such as SOAP, xml over http, http posts, etc., that has the LMS code or ID in the song code, such as S AB 1234. The tcp-ip address of the MMM 24 is well known to the app. The app then forwards the message to the MMM 24 directly over the wireless communication link, such as the wireless Internet link using established transmission formats, such as 4G, lte, 3G Edge, GPRS, etc.

Upon receipt of the message from user's app, the MMM 24 creates a reply to the user which may contain text, images, etc., using the tcp-ip address of the user's mobile device to acknowledge receipt of the song selection, and other information as described above. The MMM 24 then forwards this reply to the user's app for viewing by the user.

At the same time, the MMM 24 sends the user request along with play criteria, such as a standard, recommendation or priority request, to a location media server (LMS) coupled to the selected A/V device 14. This communication is via the Internet 12 to the selected A/V device 14 to implement the digital media selection at any premium or standard schedule.

It will be noted that the transmission of the digital media selection signals from the MMM 24 to the LMS and the selected A/V device 14 can also include the entire selected digital media, or simply a signal to the A/V device 14 to play a particular digital media already stored in the memory of the selected A/V device 14 or its LMS.

The MMM 24 can also send only a signal to the LMS, such as LMS 140, 142, or 144, each coupled to one or more A/V devices 14, send a command to one of the LMSs 140, 142, or 144, with three shown by way of example only in FIG. 1, in the form of a command to one particular LMS, such as LMS, 140 to play the user selected digital media on one particular A/V device 14 coupled to the selected LMS 140, as well as identifying the location of the selected digital media. The location of the selected digital media can be in the content database 50. In this case, the MMM 24 extracts the complete selected digital media from the content database 50 which is then transferred through the MMM 24 and the Internet 12 to the selected LMS 140.

The LMS 140, 142 and 144 can each be embodied in a server which can be any suitable computing device having a central processor executing a control program stored in a memory, either formed as part of the LMS or separate from, but disposed in communication with the processor of the LMS.

As will become more apparent hereafter, each LMS 140, 142 and 144 has an A/V output 139 hardwired or coupled in wireless communication with the one or more A/V units 14 associated with a particular LMS, such as LMS 140. The A/V output 139 is capable of converting the digital content received from the content database 50 in accordance with the user selection to audio video signals which can be played by the A/V unit 14.

The MMM 24 is also capable of sending a message through the SMSC to the user 16 thanking the user for making the selection. This will confirm that the selection has been implemented. At the same time, the message to the user 16 can include other messages, such as an offer to buy the selected song or video at a particular price or the ability to purchase or download as wall paper to the user 16 pictures of the artist performing the selected song or performing in the selected video.

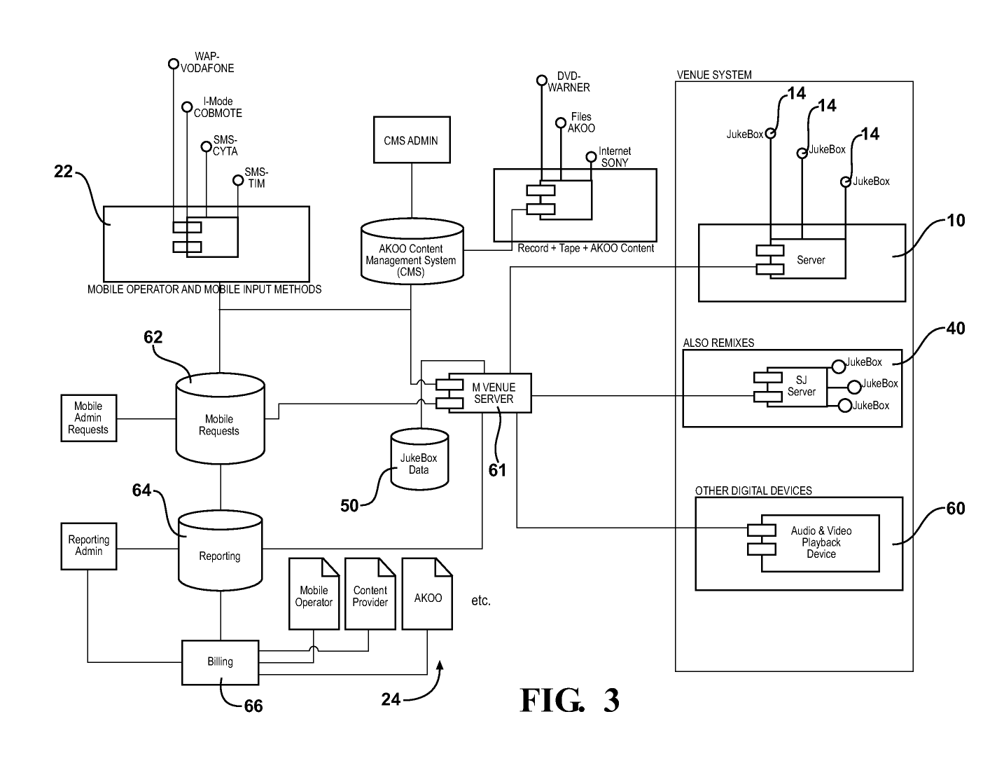

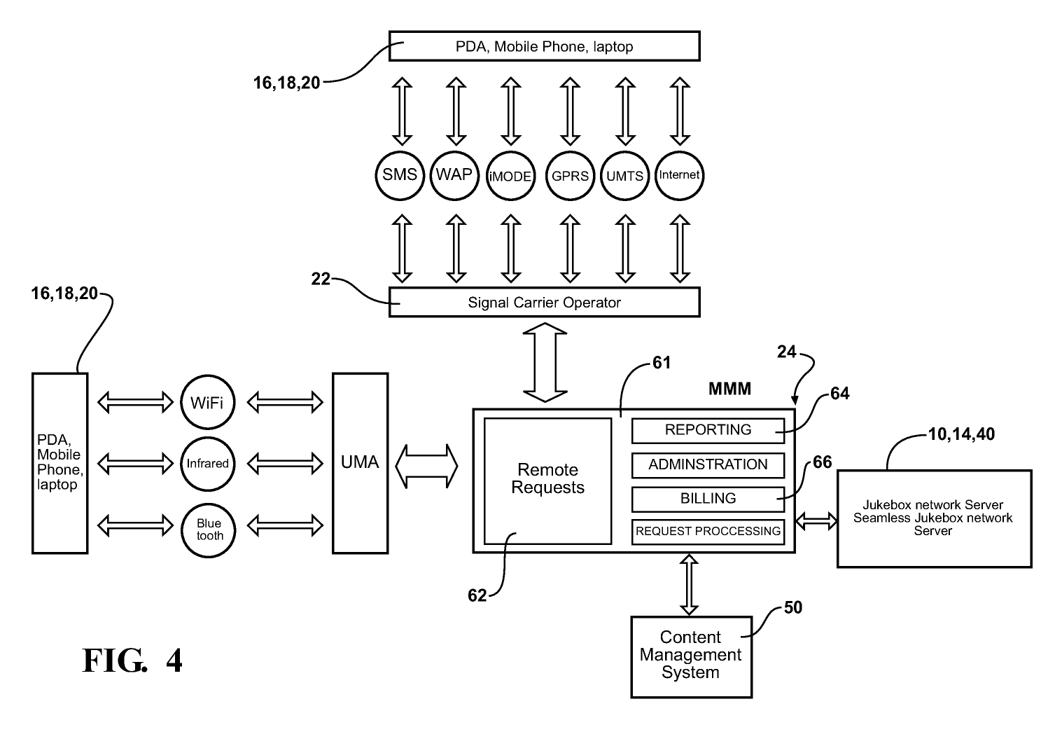

FIGS. 3 and 4 depict block diagrams of the major components of the control means or mobile media manager 24. The MMM 24 includes a so-called m-Venue server 61 which communicates with any of the A/V devices 14 and LMS 140, 142 and 144.

An example of a device or a system that can be used as a basis for implementing the system and functionality described herein on the server 61 is a computing device or computer. The computer can be any suitable computer or computing device. As an example, the computer can include one or more processors, such as a central processing unit (CPU) and memory, such as RAM memory and ROM memory. A storage device can be optionally provided in the form of any suitable computer readable medium, such as a hard disc drive. One or more input devices such as a keyboard and mouse, a touch screen interface, etc., allow input to be provided to the CPU. The display, such as liquid crystal display (LCD) or a cathode-ray tube (CRT) allows output to be presented to the user. A communication that is operable to send and receive data or other signals using the networks 12 or 22. Each user request is also forwarded to a reporting module 64 which is in communication with the m-Venue server 61 to record each user request and the validation of a successful digital selection. The reporting module 64 communicates with a billing module 66 which suggests the fee for each user request. The MMM 24, as described above, can receive a remote content of digital media selection signal from any source. The MMM 24 then checks the selection for validity, processes it, stores it in a database, and forwards the request to the network server 10 in the aspect shown in FIG. 1.

The LMS 140 receives the A/V data or stream from the MMM 24 and tries to the place the request to the specified A/V device 14. If this is successful, the LMS 140 then replies with a success message to the waiting MMM 24. If for any reason there is a failure in the request process, such as the A/V device 14 not responding, the transmission network is down, etc., the LMS 140 replies to the MMM 24 with a failure message along with the reason of the failure. Once the MMM 24 has received an answer to the remote content selection signal, the MMM 24 records the answer in the database and informs the user with the result of his request.

A user request from any of the mobile user interface devices 16, 18, and 20 is communicated through the network 22 to a mobile request control means 62. The user request is then communicated to the m-Venue server 61 for digital content selection at a specific digital audio-visual playback device 14, etc.

Each user request is also forwarded to a reporting module 64 which is in communication with the m-Venue server 61 to record each user request and the validation of a successful digital selection. The reporting module 64 communicates with a billing module 66 which suggests the fee for each user request.

One aspect of an expanded mobile media manager network 100 coupled to multiple A/V devices 14 are in depicted FIG. 1. In the network 100, the MMM 24 is referred to as the primary or master MMM 24. At least one and, for example, a plurality of additional mobile media managers, with three additional mobile media managers 102, 104 and 106, depicted by way of example only in FIG. 1, are coupled in data communication with the master MMM 24. Although any or all of the additional MMMs 102, 104, and 106 may be physical servers, in the same manner as the master MMM 24, in this aspect, the additional MMMs 102, 104, and 106 are virtual MMMs.

The virtual MMMs 102, 104 and 106 are implemented in a computer readable medium or software to perform the same functions as the master MMM 24. The software program is executed by a processor in a server or other computing device. Such processor or computing devices may be part of the master MMM 24 and or in a separate server located in the same physical location or data center as the master MMM 24. Alternately, the computing device or server containing the software program medium implementing each or all of the virtual MMMs 102, 104, and 106 may be physically located separate or remote from the master MMM 24 in a different location or datacenter.

As shown in FIG. 1, and in greater detail in FIG. 2, the MMMs 102, 104, and 106 share communication paths with each other and with the master MMM 24 in the network 110. Communications paths, all denoted by reference number 111, may be any combination of hardware, wireless, etc. The communication paths 111 are arranged in a so-called “mesh” arrangement to allow the master MMM 24 to communicate with each of the virtual MMMs 102, 104, and 106 or to communicate simultaneously with all of the virtual MMS 102, 104 and 106. Each of the virtual MMMs 102, 104, and 106 can also communicate with one or both of the other virtual MMMs. In this manner, each of the MMMs 24, 102, 104 and 106 have access to the digital media content database 50 as well as any other media content stored in a memory associated with any of the MMM's 24, 102, 104 and 106.

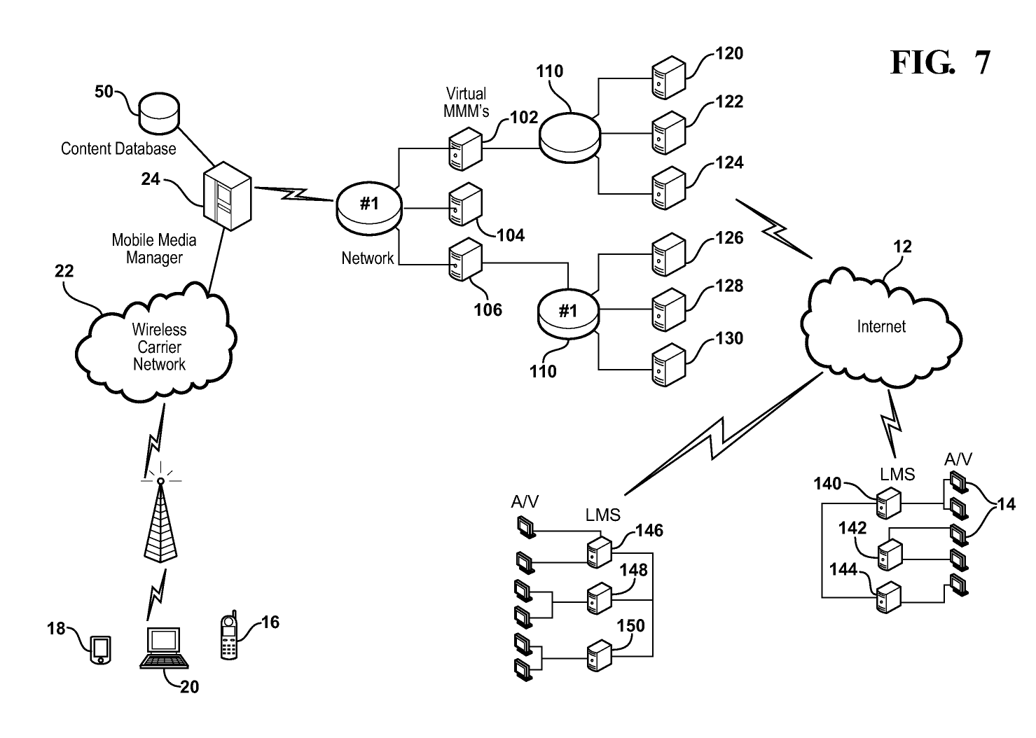

Optionally, as shown in FIG. 7, all or certain ones of virtual MMMs 102, 104, and 106 may communicate, either by a hardware or a wireless communication path or combinations thereof, with one or a plurality of virtual sub-MMM's such as sub MMM's 120, 122, and 124 for the virtual MMM 102. Virtual sub MMMs 126, 128 and 130 maybe coupled in data communication via a network 110 to virtual MMM 106. Although virtual MMM 104 is not depicted as having any sub-virtual MMMs, it will be understood that the virtual MMM 104 could also have one or more sub-virtual MMMs.

It will be understood that although three sub MMM's are illustrated in FIG. 7 for each or some of the virtual MMMs 102, 104 and 106, the sub MMM's may be provided in any number or not at all for any of the virtual MMMs 102, 104 and 106.

The sub MMM's, such MMM 120, 122 and 124, can also be embodied in physical servers or, for example, as virtual MMM's residing in a physical server containing the immediate parent MMM or in the server in the data center containing the master MMM 24, or in completely separate servers in separate locations.

The MMMs 102, 120, 122 and 124, and/the MMMs 106, 126, 128 and 130 may be connected in any hierarchal arrangement, such as a tree, or the indicated mesh/star arrangement 111 shown in FIG. 2, wherein each 102, 120, 122 and 124 are coupled in communication with each other so that all data is accessible by each different mobile media manager.

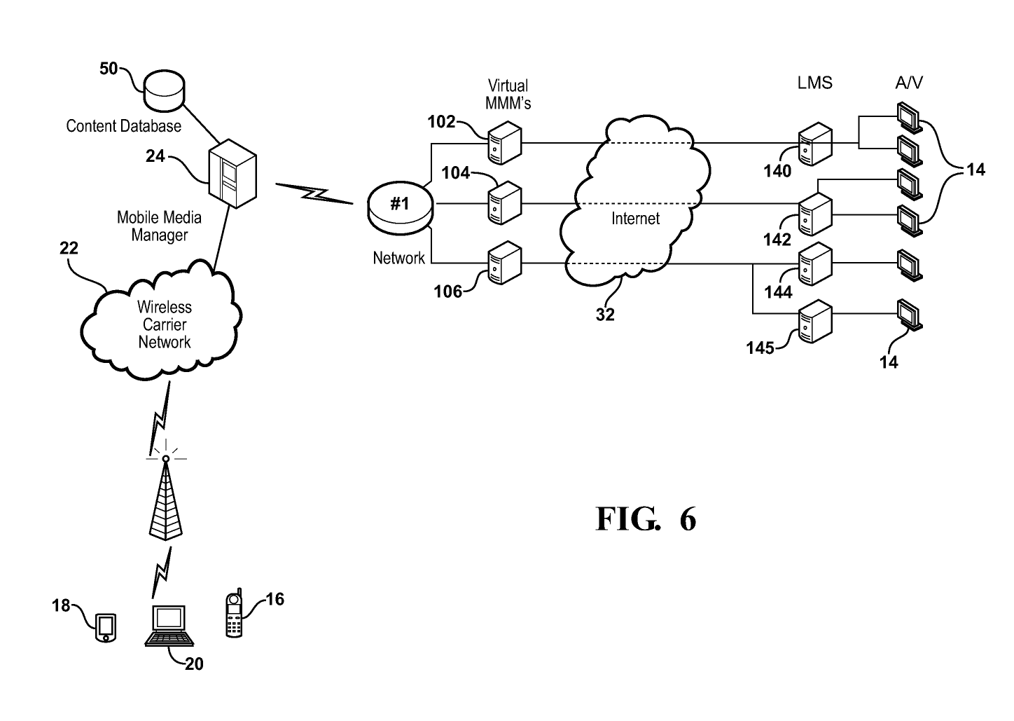

In a tree network, instead of the mesh/star network 111, the virtual sub MMMs 120, 122 and 124 are directly coupled to the corresponding virtual MMM 102, in the same manner as the network connections shown in FIG. 6, and do not include any communication with the other virtual sub MMMs 120, 122 and 124.

Combinations of tree/hierarchal and mesh/star networks may also be used for the virtual sub MMMs 120, 122, 124, and/or 126, 128 and 130.

Referring now to FIG. 6, there is depicted a modification of the interactive content request apparatus shown in FIG. 1. In this aspect, each virtual MMM 102, 104 and 106 can communicate only with a single LMS, such as LMS 140 for virtual MMM 102, LMS 142 for virtual MMM 104 and LMS 144 for virtual MMM 106. It should be noted that, for example, the virtual MMM 106 is illustrated in FIG. 6 as being disposed in data communication with two LMSs 144 and 146.

As described previously, each LMS 140, 142, 144 and 145 may be coupled to one or a plurality of A/V units 14.

This tree or hierarchal network between the virtual MMMs 102, 104 and 106 and the LMSs 140, 142, 144 and 145 is expandable to any number of virtual MMMs and any number of LMSs, with each virtual MMM coupled to one or more LMSs and each LMS coupled to one or more A/V units.

The sub MMMs 120-130 communicate either wirelessly or via hardwire connections or by a combination of both the wireless and hardwire, with an Internet connection 12 illustrated in FIG. 7 by way of example only, to one or more location media servers (LMS), such as LMS's 140 and 142, 144, 146, 148 and 150. One or more LMS servers may be coupled to each sub MMM 120-130.

Further, each LMS 140, 142 and 144, etc., is coupled, either wirelessly, by hardwire or by a combinations thereof, to one or more A/V units 14. For example, the LMS 140 is coupled to two A/V devices 14. The LMS 144 is coupled only to a single A/V device 14, for example only.

The illustrated hierarchal arrangement of MMMs from master to sub-MMMs and through multiple MMMs to multiple A/V devices 14 provides network accessibility for streaming or supplying audio or visual content from the content database 50 to any A/V device 14. Further, the virtual and sub MMM's have the capability to determine which MMM has the resources, available processor time, operating speed etc., to supply a user request of selected media content of content database 50 to a selected A/V device 14.

As also shown in FIG. 1, a streaming audio-video server 60, embodied in the form of a computing device having a processor executing a stored controlled program stored in a memory coupled to the processor, is itself coupled in wireless, hardwire or combinations thereof communication with the master MMM 24, the network 110 between the master MMM 24 and the one or more virtual MMM's 102, 104 and 106, as well as the Internet 12. The streaming audio-video server (SAVS) 60 contains A/V software which converts the digital format of a selected digital media in the content database 50 identified in a user request into a streaming audio-video format. This streaming A/V format can be specific to the particular A/V 14 identified in the user request.

The SAVS 60 is capable, upon receiving a command from the master MMM, to retrieve a selected digital media identified in the user request from the content database 50, convert the digital media to streaming A/V format and then transfer the streaming A/V stream either directly through the Internet 12 to the identified LMS 140, 142, or 144 and then to the selected A/V device 14 or to one of the virtual MMMs 102, 104, and 106, which in turn handles the transfer of the digital media to the selected LMS 140, 142, 144 and the specific A/V 14 device.

The connection between the SAVS 60 through the network 110 to the virtual MMM's 102, 104 and 106 enables the virtual MMM's 102, 104 and 106 to communicate with and query the SAVS 60 in the same way as the master MMM 24 described above.

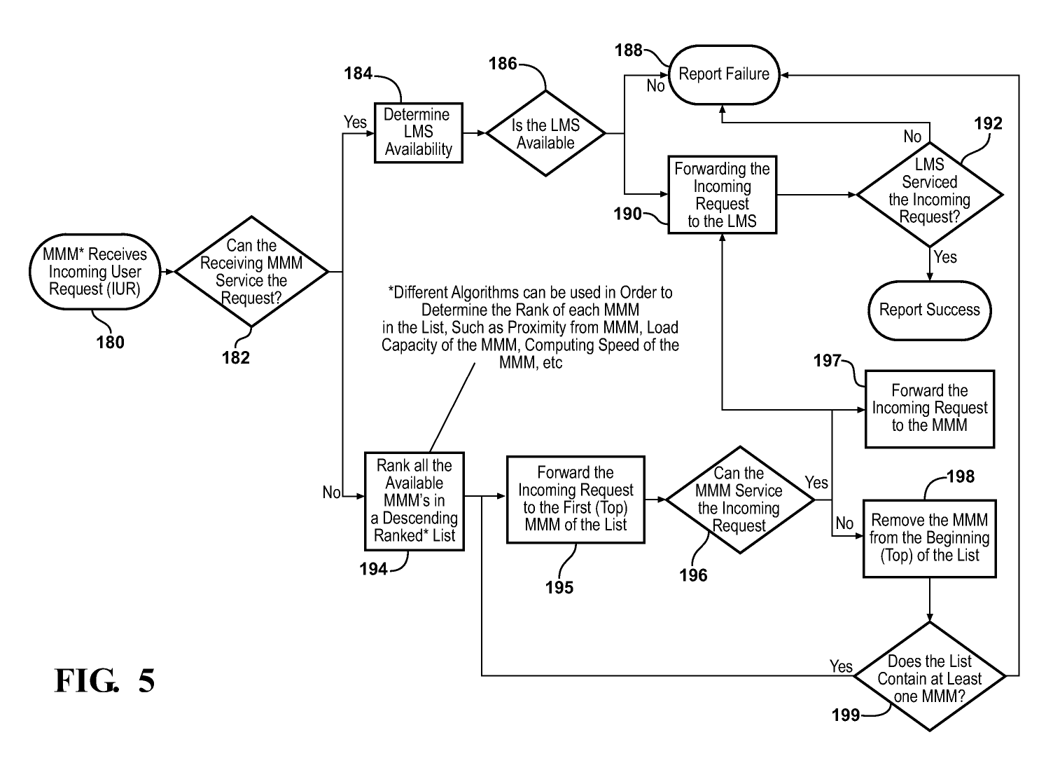

As shown in FIG. 5, the master MMM 24, which can communicate with any of the virtual MMM's 102, 104 and 106, receives an incoming user request in step 180. The master MMM 24 first determines in step 182 whether it can service the user request to supply selected media content to an A/V device 14 specified in the user request.

The master MMM 24 uses various factors to determine if it can service received user request. Such factors can include, for example, but not limited to is the master MMM 24 operating, does the master MMM have the data processing capability to handle in incoming user request at the time of the user request or within a predetermined time period after receiving the user request, etc.

Each sub or virtual MMM 102, 104 and 106 also has the capability to execute the same ranking algorithm used by the master MMM 24, as described above, in the event that the master MMM 24 is not able to service an incoming user request. In this situation, the top most ranked virtual MMM 102, 104 and 106 will perform the functions of the master MMM 24 shown in FIG. 5 and rank the other MMM 102, 104, and 106 in a predetermined order based on the same algorithm factors described above for the master MMM 24, in the event that the top most MMM 102, 104, and 106 is not able to service an incoming user request.

If the receiving MMM 24 can service the user request in step 180, the receiving MMM 24 determines the availability of an LMS. If an LMS, such as LMS 140 or 142 is available, operating and coupled to the specified A/V device 14, the master MMM 24 determines if the LMS 140 or 142, is available to process the user request. In determining if the LMS 140 or 142 is available to process the user request, the master MMM 24 determines if the particular LMS, 140 or 142, is currently in an operative state, whether LMS 140 or 142 has the capability to handle the amount data associated with the user request, can the selected LMS 140 or 142 handle the transfer of the data associated with the user request to the selected A/V device in a timely fashion, or can the LMS 140 or 142, using predetermined rules of play for user request at the location of the selected A/V device, such as parental controls, time of day factors, types of digital content playable at the location of the A/V, etc.

In step 186, if the available LMS is not able to process the user request in step 184, the receiving MMM 24 reports a failure in step 188.

If, however, the LMS is available to process the user request, the receiving MMM 24 forwards the incoming user request to the selected LMS in step 190. The receiving MMM in step 192 then determines if the LMS servicing the incoming request by transmitting selected media content to the selected AV device 14. If the selected LMS did fully service the incoming user request, the receiving MMM 24 reports a successful event and can begin processing an invoice to the user as well as a return completion message, as described above.

Referring now to FIG. 1, there is depicted another aspect of the present digital media selection and play network. In this aspect, a streaming audio-video (A/V) storage database 160 is disposed in data communication with the master media manager controller 24, by either hardwire, wireless communication or a combinations thereof. The streaming A/V storage 160 communicates with the streaming A/V server 60.

This arrangement enables streaming A/V content to be selected by a user, communicated through the MMM 24 via the Internet to the A/V server 60 which selects the desired streaming content and transmits the content through the Internet 12 to a selected LMS which then streams the A/V content through the A/V output of the LMS 140 to the selected A/V device 14.

Referring back to step 182, if the receiving MMM 24 cannot service the request, the MMM 24 ranks all of the available sub MMMs 102, 104, and 106, in a descending rank list according to pre-selected parameters. Different algorithms or parameters can be used to determine the rank of each MMM in such a list, such as proximity from the master MMM 24, the capacity of each MMM, the computer speed of each MMM, current data processing activities, etc.

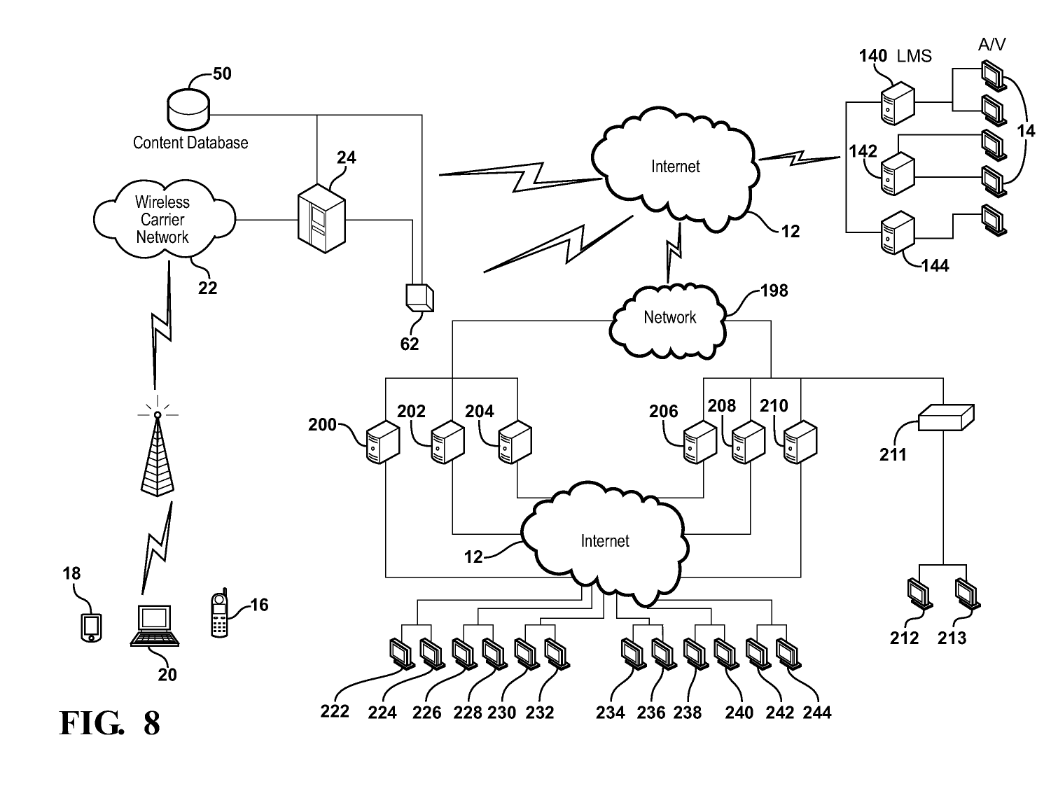

Another aspect of the present apparatus and method for handling interactive content requests is shown in FIGS. 8-10.

The MMM 24 can also send only a signal to the LMS, such as LMS 140, 142, or 144, each coupled to one or more A/V devices 14, and/or send a command to one of the LMSs 140, 142, or 144, with three shown by way of example only in FIG. 8, in the form of a command to one particular LMS, such as LMS 140, to play the user selected digital media on one particular A/V device 14 coupled to the selected LMS 140, as well as to play the selected digital media and identifying the location of the selected digital media. The location of the selected digital media can be in the content database 50. In this case, the selected LMS 140 can communicate through the MMM 24 to the content database 50 to extract the complete selected digital media which is then transferred through the MMM 24 and the Internet 12 to the selected LMS 140.

Alternately, the MMM 24 can extract the digital media identified in the user request and transmit the entire selected digital media to any of the LMS's 140, 142 and 144.

As also shown in FIG. 8, a streaming audio-video server 60, embodied in the form of a computing device having a processor executing a stored controlled program stored in a memory coupled to the processor, is itself coupled in wireless, hardwire or combinations thereof communication with the master MMM 24, as well as the Internet 12. The streaming audio-video server (SAVS) 60 contains A/V software which converts the digital format of a selected digital media in the content database 50 identified in a user request into a streaming audio-video format. This streaming A/V format can be specific to the particular A/V device 14 identified in the user request.

The SAVS 60 is capable, upon receiving a command from the master MMM 24, to retrieve a selected digital media identified in the user request from the content database 50, convert the digital media to streaming A/V format and then transfer the streaming A/V stream directly through the Internet 12 to the identified LMS 140, 142, or 144 and then to the selected A/V device 14 or back to the MMM 24 for transfer to the LMSs and A/V device 14.

The LMS 140, 142 and 144 can be embodied in a server which can be any suitable computing device having a central processor executing a control program stored in a memory, either formed as part of the LMS or separate from, but disposed in communication with the processor of the LMS 140.

As will become more apparent hereafter, each LMS 140, 142 and 144 has an A/V output hardwired or coupled in wireless communication with the one or more A/V units 14 associated with a particular LMS, such as LMS 140. The A/V output is capable of converting the digital content received from the content database 50 in accordance with the user selection to audio video signals which can be played by the A/V unit 14.

Referring back to FIG. 8, a user request is transmitted at least in part through a wireless carrier network 22 to a global media management controller or MMM 24. The MMM 24 is disposed in communication by hardwire or wireless or combinations thereof transmission to a media content database 50 containing individual selectable digital media.

The MMM 24 is coupled through the Internet 12 to at least one location media server or LMS 200. The LMS 200 can be a physical or virtual computing device located in a data center which can be the same or separate and remote from the physical location of the MMM 24. For example, the LMS 200 may be embodied in a set top box located in a person's home.

The difference between a physical LMS and a virtual LMS is based on the hardware coupling between the LMS and its associated A/V device. In both a physical LMS and virtual LMS, the streaming A/V output stream is performed by audio visual player software executed in the LMS. A physical LMS has the A/V player software executed directly in the LMS hardware or server. A virtual LMS has the LMS functionality and the A/V player software executed on a server without any A/V output devices directly connected to the server. Instead, the A/V player software streaming the video to the A/V output device is coupled between the server running the virtual LMS software and the A/V device by the Internet in suitable formats, such as tcp/ip, udp, etc.

The A/V player software can be specific to a particular type of A/V device. Thus, the virtual LMS will have A/V specific software executed in its server for streaming the A/V media to the specific A/V device.

The A/V signals output by a physical LMS can be either an analog signal or digital signal recording to HDMI, SCART, VGA, SVIDEO, etc.

The A/V stream output of a virtual LMS is a binary stream of encoded video in a suitable format, such as xvid, mpeg4, avi, mov, raw, etc., formats. These formats are similar to the video files that typically reside in a computer.

A virtual LMS will also know the identifier or address of the specific A/V device to which it will stream the A/V output. Similarly, each A/V device employed with a virtual LMS will also know from its installed software the identifier of which virtual LMS it needs to connect it via the Internet to get the A/V stream.

By way of example only, the master MMM 24 communicates through the Internet 12 to a plurality of LMSs, including LMSs 200, 202, 204, 206, 208 and 210.

It will be understood that any number of LMSs 200-210 may be employed with a single MMM 24.

It will be understood that although the following description of the LMSs 200-210 describes such LMSs as virtual LMSs, any one of the LMSs 200-210 could be a physical LMS which, as described above, is directly coupled to one or more A/V devices 14. As shown in FIG. 8, a physical LMS 211 is coupled through the network 198 with virtual LMSs 206, 208 and 210. It will be understood that the physical LMS 211, in which the functional software of the LMS is executed by a processor in a separate server or computing device, can also be a stand-alone LMS without any interconnectivity with the virtual LMS's 206, 208 and 210.

The physical LMS 211 is directly coupled, such as by hardwired, wireless connections, or combinations of both, to at least one or a plurality of A/V devices, with 2 A/V devices 212 and 213 being shown in FIG. 8 by way of example only.

In the case of virtual LMSs, any of the LMSs 200-210 maybe embodied in software in a server, either in the same data center as the MMM 24, or in a data center separate and remote from the MMM 24. Further, two or more of the LMSs 200-210 may be embodied in the same server located in a single data center. Alternately, each of the LMSs 200-210 may be embodied in separate servers located in separate data centers or at separate locations.

The communication path from the master MMM 24 through the Internet 12 to the LMSs 200-210 uses the Internet which allows the MMM 24 to communicate directly with each individual LMS 200-210.

A plurality of audio-visual or A/V devices 222, 224, 226, 228, 230 and 232, 234, 236, 238, 240, 242, and 244, with the number of A/V devices being described and illustrated by way of example only, are individually selectable. The A/V devices 202 can be so called “smart” devices where each includes a processor, either in the form of a microcontroller, microprocessor, or other computer component capable of executed stored program instructions. Each processor in each A/V device 222-244 can be coupled to its own memory for storing data, digital media and the program instructions. For example, any A/V 222-242 can be a smart A/V, such as a tablet computer, i.e., iPad, a smartphone, i.e. iPhone, and Internet compatible television or Inet, video game console etc.

Any number of A/V devices, such as one or more A/V devices 14, can be coupled and controlled by a single LMS. For example, A/V devices 222 and 224 are coupled to the LMS 200. Similarly, the A/V devices 226 and 228 are coupled to the LMS 202.

Some or all of the A/V devices 200-242 may have different operating characteristics and may require different communication protocols. It can be difficult to provide one LMS 200 with sufficient capability to interact and communicate with each different type of A/V device 222-242. To overcome this hurdle, at least one and, for example, the plurality of virtual location media servers 200-210 can each include different A/V device software to enable the virtual LMSs to stream the A/V output to the specific A/V device in the format which can be acted on by the specific A/V device to generate the streaming A/V output.

Each virtual LMS 200-210 is embodied in a computer readable medium executed by a processor in a server or other computing device to provide the same functions as the physical LMS 200. However, each individual LMS 200-210 can have its program instructions tailored to the particular A/V devices with which it is coupled in data communication.

LMS 200 maybe, for example, a virtual LMS associated with one particular user where the user has two distinct A/V devices which are capable of displaying or playing digital audio/visual media. The request from the same user is transmitted through the carrier network 22 to the MMM 24. The MMM 24 determines the appropriate LMS for transmission of the digital media, which can be sent as a complete block of data or in a continuous stream. The MMM 24 forwards the media content identified by the user from the database 50 through the Internet 12 to the LMS 200 which is coupled to one specific A/V device contained in the user request. The request from the user contains an ID code for a specific A/V device 222 or 224. A subsequent request from the same user for the same digital media may simply switch the A/V device to which the media is sent or streamed to a different A/V device associated with the LMS 200, such as A/V device 224. This provides flexibility to each user to control and switch the selected digital media content to an appropriate A/V device on which the user wishes to see a selected media.

It is also possible to modify the LMS configuration shown in FIG. 8 by introducing a physical LMS between the Internet 112 and the LMS network 198. The physical LMS, not shown in FIG. 8, can thereby function to select which virtual LMS 200-210 is associated with the specific A/V device, such as A/V device 222, contained in the user request for the display of the selected media content. The physical LMS will utilize the network 198 to communicate independently with each virtual LMS 200-210.

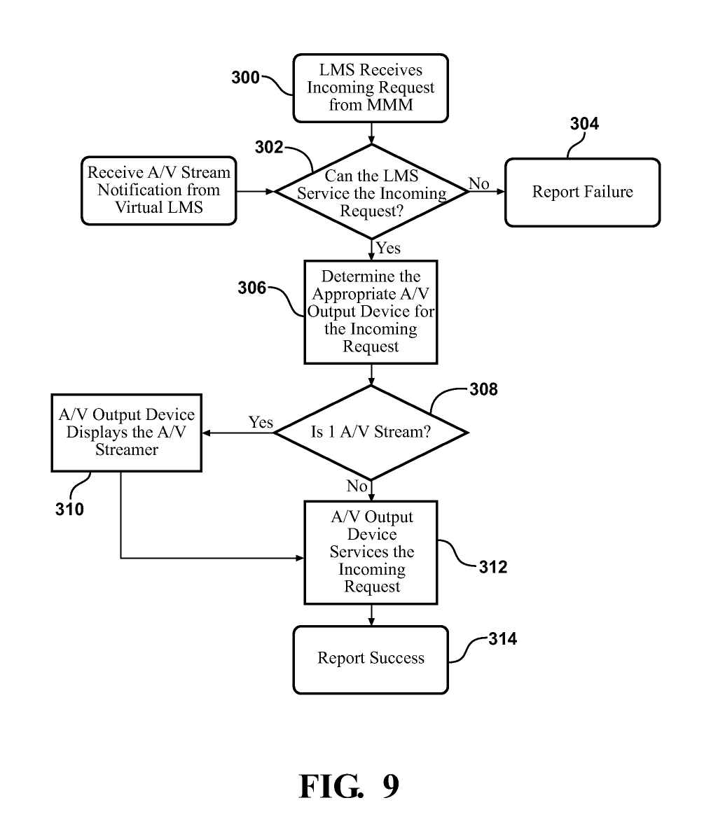

FIG. 9 depicts a flow chart of program control where, as described above, one, LMS, such as LMS 200, receives the incoming user request from the MMM 24 in step 300.

Next, in step 302, the LMS 200 determines whether or not it can service the incoming request. If not, a default or report failure sequence is entered in step 304. If, however, the LMS 200 can service the incoming request, the LMS 200 in step 306 determines the appropriate A/V output device specified in the incoming request.

Next, in step 308, the LMS 200 determines if the selected media content is an A/V stream. If the media is an A/V stream, the stream is forwarded by the LMS 200 to the selected A/V device 222 in step 310 so that the A/V device 222 displays the A/V stream.

If the selected media forwarded from the MMM 24 to LMS 200 is not an A/V stream, the media is forwarded in step 312 to the selected A/V device which can service the incoming user request. Either at the beginning of the data stream or the transfer of data to the selected A/V device or at the completion of the A/V stream or play of the selected digital media, a report is generated in step 314 to the user and/or the manager of the MMM 24 of a successful media transfer.

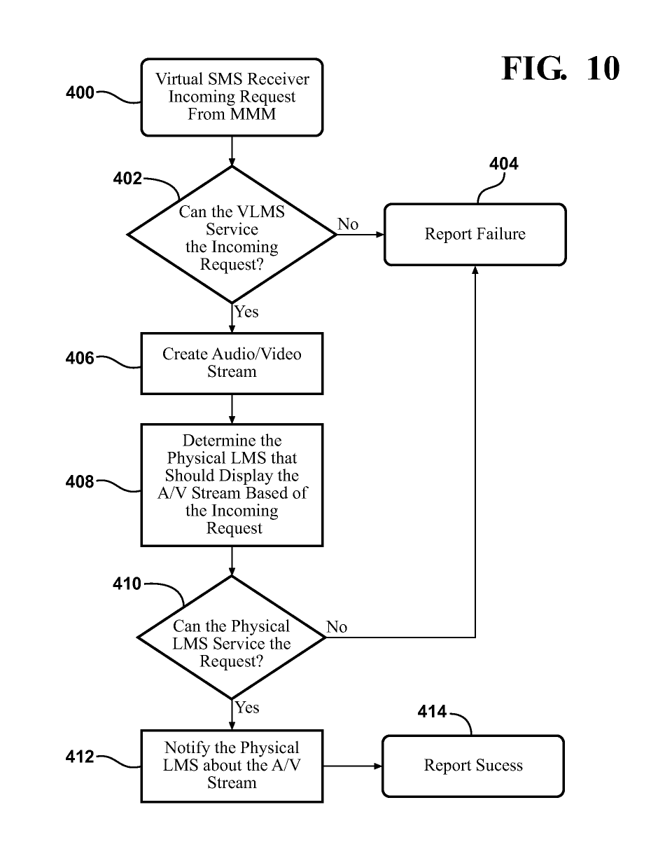

FIG. 10 depicts and alternate flow sequence where one of the virtual LMSs 202-210 receives an incoming user request through the LMS 200 from the MMM 24 in step 400. In this flow sequence, the virtual LMS which received the incoming user request from the MMM 24 determines if it can service the incoming request in step 402. If not, the default report failure sequence is initiated in step 404.

If the receiving LMS can service the incoming user request, the LMS creates an audio/video stream in step 406. The receiving LMS then determines in step 408 which should display the A/V stream as specified in the incoming user request. The virtual LMS then determines in step 410 whether it can service the user request. If no, the default or report failure sequence is entered in step 404. If yes, the virtual LMS notifies the initial LMS that received the request in step 412 about the A/V stream and then reports successful A/V stream transfer in step 414 to the MMM 24 for user billing, reporting the successful media transfer to the user, record keeping, etc.

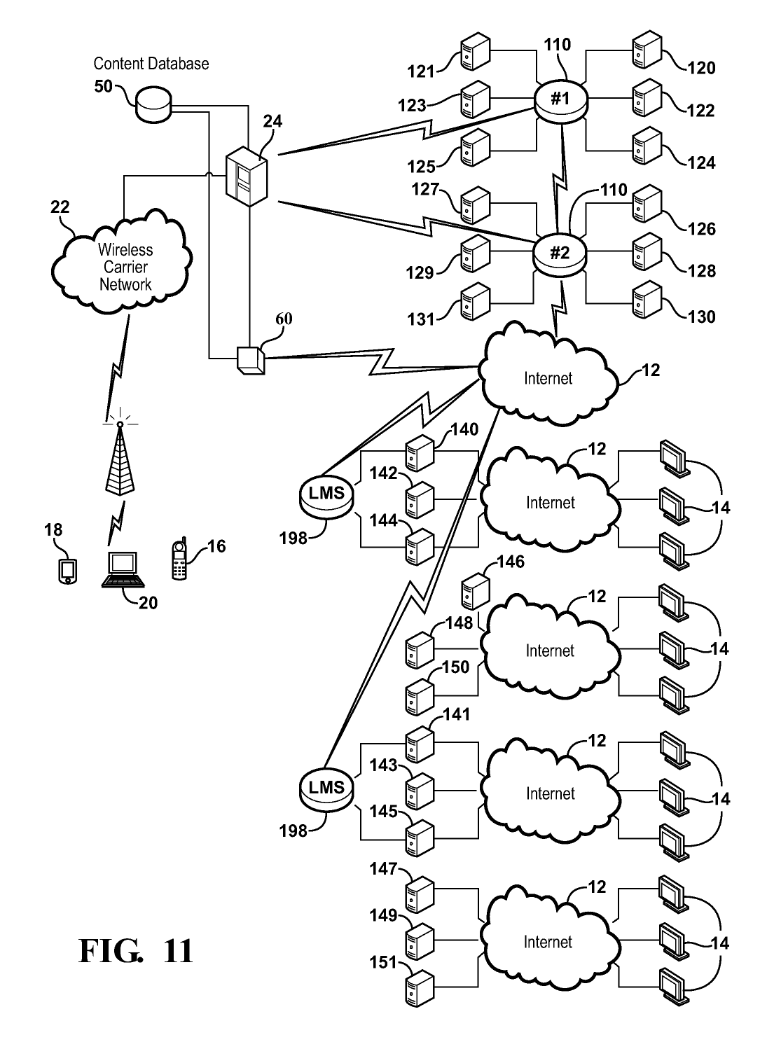

Another aspect of the present apparatus and method for handling interactive content requests is shown in FIG. 11. This aspect generally combines the features of the virtual MMM networks shown in FIGS. 1, 6 and 7 with the virtual local media server networks shown in FIG. 8.

As seen in FIG. 11, a plurality of virtual MMMs 120, 122, 124, 126, 128 and 130 are coupled by separate tree or star/mesh networks 110. Additional virtual MMMS 121, 123, and 125 are coupled to the mesh network 110 with the virtual MMMS 120, 122, and 124. Similarly, additional virtual MMMS 127, 129, and 131 are coupled to another mesh network 110 coupled to virtual MMMS 126, 128 and 130.

It will be understood that the six virtual MMMS coupled in each network 110 is by way of example as each network 110 may interconnect more or less virtual MMMS as needed for a particular system or application.

The first mesh network 110 interconnects the virtual MMMS 120-125 to each other and to the master MMM 24. Similarly, the second mesh network 110 connects the virtual MMMs 126-131 to each other and also to the master MMM 24. In this manner, each of the virtual MMMs 120-131 has access to and can receive user requests as well as media content from the content database 50 for use in meeting the specifications of a particular user request.

Each of the networks 110 couples the associated virtual MMMs 120-131 through a hardwired or wireless connection, or a combination of hardwired and wireless connections, to the Internet 12 and from the Internet 12 to one or, by example, two local media server networks both denoted by reference number 198 as described previously and shown in FIG. 8, each network 198 couples a plurality of local media servers, which may be all be virtual media servers, such as servers 140, 142, 144, 146, 148 and 150 to each other and to the virtual MMM networks 110. In this manner, each of the virtual MMMs 120-130 may communicate with any of the virtual LMSs 140, 142, 144, 146, 148 and 150 in a direct one to one tree hierarchy network or in a star/mesh network where any virtual MMM 120-131 can communicate with any virtual LMS 140, 142, 144, 146, 148 and 150.

A second virtual LMS network 198 is also coupled through the Internet 12 to one or both of the virtual MMM networks 110. The second LMS network 198 couples an additional plurality of virtual LMSs 141, 143, 145, 147, 149, 151 to each other and to one or more or all of the virtual MMMs 120-131.

This combined hierarchical and mesh network arrangement expands the ability of the master MMM 24 to provide media content from the content database 50 to any of an enlarged number of A/V devices 14 located in many different locations. This arrangement also enables the virtual MMMs and virtual LMSs to be located at any convenient data center or server farm, either in the same location as the master MMM 24 or, more typically, at the diverse geographic locations consistent with the location of the A/V devices.

It will be understood that each of the virtual MMMs 120-131 can communicate with any of the virtual LMSs 140-151. Alternately, each virtual MMM 120-131 may be configured for communicating with only a specific virtual LMS 140-151 in a hierarchal tree one-to-one arrangement. Combinations of the above two configurations may also be provided using the network arrangement shown in FIG. 11.

The streaming audio-video server 60 can be implemented in the media network in FIG. 11, in the same manner as described above and shown in FIGS. 1 and 8 in order to provide streaming audio-video signals to any selected A/V device 14 through the virtual MMMs and virtual or physical LMSs.

1. A method for digital content selection and play comprising the steps of:
receiving, by a master media manager controller, a user request, requesting a digital media for play on a one audio-visual playback device;
disposing at least one virtual media manager controller residing in a computer readable medium of a computing device in data communication with the master media controller;
disposing at least one virtual local media server in communication with the master media controller, the at least one virtual local media server residing in a computer readable medium of a computing device;
disposing at least one audio-visual device in communication with the at least one virtual local media server;
in response to a user request, accessing, by the master media manager controller, a store of digital media content to locate the digital media in the user request; and
transmitting the located digital media by the master media manager controller through the at least one virtual mobile media manager controller and one of the at least one local media server to the at least one audio-visual device for play of the identified digital media by the at least one audio-visual device.

2. The method of claim 1 further comprising:
providing a plurality of virtual media manager controllers in communication with the master media manager controller;
providing a plurality of local media servers, at least one local media server disposed in communication with each virtual media manager controller; and
at least one audio-visual device disposed in communication with each local media server.

3. The method of claim 3 further comprising the steps of:
disposing the plurality of virtual media manager controllers and the master media manager controllers in communication with each other such that each one of the master media manager controller and the virtual master media manager controller are able to access the store of digital media content.

4. The method of claim 3 wherein:
the plurality of virtual master media manager controllers and the master media manager controller are coupled in a mesh network with each other.

5. The method of claim 3 wherein:
the plurality of virtual media manager controllers and the master media manager controller are coupled in a hierarchal tree network.

6. The method of claim 2 further comprising the step of:
each of the master media manager controller and the virtual master media manager controller are configured for receiving a user request.

7. The method of claim 5 further comprising:
determining by the one of the master media manager controller and the virtual master media manager controllers that receives an incoming user request if the receiving one of the master media manager controller and the virtual media manager controllers can service the user request;
if yes, determining by the one of the receiving master media manager controller and the virtual media manager controllers, the availability of one of the local media servers disposed in communication with the receiving one of the master media manager controller and the virtual media manager controllers; and
if yes, forwarding by the one of the receiving master media manager controller and the virtual media manager controllers the digital media in the user request to the selected local media server.

8. The method of claim 7 further comprising:
if the one of the receiving master media manager controller and the virtual media manager controllers cannot service the incoming user request, the master media manager controller ranking all of the available virtual media manager controllers in descending rank according to ranking parameters;
forwarding the incoming user request to a first ranked virtual media manager controller;
determining by the first ranked virtual media manager controller if it can service the incoming user request;
if yes, forwarding by the receiving one of the master media manager controller the media content in the incoming user request to the first ranked virtual media manager controller.

9. The method of claim 8 further comprising:
if the first ranked virtual media manager controller cannot service the incoming user request, removing by the master media manager controller the first ranked virtual media manager controller as the first ranked virtual media manager controller; and
forwarding digital media content in the incoming request to the next highest ranked virtual media manager controller.

10. The method of claim 3 further comprising the step of:
configuring each of the virtual local media servers for receiving a user request.

11. The method of claim 10 further comprising:
determining by the one of the virtual local media servers that receives an incoming user request if the receiving one local media server can service the user request;
if yes, the receiving LMS-one local media server determining the availability of the virtual local media server disposed in communication with the selected audio-visual device identified on the user request; and
if yes, the receiving one local media server forwarding the digital media content specified in the user request to the selected audio-visual device.

12. An apparatus for digital content selection and play comprising:
means for receiving, by a master media manager controller, a user request, requesting a digital media for play on a specified one audio-visual playback device;
means for disposing at least one virtual media manager controller residing in a computer readable medium of a computing device in data communication with the master media controller;
means for disposing at least one virtual local media server in communication with the at least one virtual media manager controller, the at least one virtual local media server residing in a computer readable medium of a computing device;
means for disposing at least one audio-visual device in communication with the at least one virtual local media server;
means responsive to a user request, for accessing, by the master media manager controller, a store of digital media content to locate the specific one digital media in the user request; and
means for transmitting the specific one digital media by the master media manager controller through the at least one virtual mobile media manager controller and one of the at least one local media server to the selected at least one audio-visual device for play of the one digital media by the selected audio-visual device.

13. An apparatus for digital content selection and play comprising:
at least one digital audio-visual playback device capable of playing digital audio-visual media, the at least one digital audio-visual playback device having a distinct identifier;
a master media manager controller configured for receiving a user request from a user interface separate from the at least one digital audio-visual playback device, the user request identifying a distinct media content and the distinct identifier of the at least one digital audio-visual playback device;
at least one virtual media manager controller embodied in a computer executable medium in a computing device coupled to the master media manager controller;
at least one virtual local media server embodied in a computer executable medium in a computing device coupled to the at least one virtual media manager controller;
the at least one virtual media manager controller coupled by a first communication path with the at least one local media server for transferring digital media content to the at least one audio-visual playback devices; and
the at least one virtual local media server coupled by a first communication path with the at least one audio-visual playback device for transferring media content to the at least one audio-visual playback device.

14. The apparatus of claim 13 further comprising:
determining by the one of the master media manager controller and the at least one virtual media manager controller that receives an incoming user request if the receiving one of the master media manager controller and the at least one virtual media manager controller can service the user request;
if yes, determining, by the one of the receiving media master manager controller and the at least one virtual media manager controller, the availability of one of the local media servers disposed in communication with the receiving of the one media master manager controller and the at least one virtual media manager controller; and
if the one local media server is available, forwarding by the receiving one of the media manager controller and the at least one virtual media manager controller the digital media in the user request to the selected local media server.

15. The apparatus of claim 14 further comprising:
if the receiving one of the master media manager controller and the at least one virtual media manager controller cannot service the incoming user request, the receiving one of the master media manager controller and the at least one virtual media manager controller ranking all of the available virtual media manager controllers in descending rank according to ranking parameters;
forwarding the incoming user request to a first ranked virtual media manager controller;
determining by the first ranked virtual media manager controller if it can service the incoming user request;
if the first ranked virtual media manager controller can service the request, forwarding, by the receiving one of the master media controller and the at least one virtual media manager controller, the digital media content in the incoming user request to the one local media server.

16. The apparatus of claim 15 further comprising:
a streaming audio-video server coupled in communication with the master media manager controller and each of the virtual media manager controllers;
the streaming audio-video server executing a stored control program for converting a digital format media to a streaming audio-video signal.

17. The apparatus of claim 16 further comprising:
the streaming audio-video server coupled in communication with the Internet for transferring a streaming audio-video signal to a selected one of the local media servers for play on a selected audio-video device.

18. The apparatus of claim 13 further comprising:
the at least one virtual local media server including a plurality of virtual local media servers; and
the master media manager controller communicating independently with each of the plurality of virtual local media servers.

19. The apparatus of claim 13 wherein:
the at least one of the virtual local media server is coupled to a plurality of audio-visual playback devices.

20. The apparatus of claim 13 further comprising:
a streaming audio-video server coupled in communication with the master media manager controller and each of the virtual media manager controllers;
the streaming audio-video server executing a stored control program for converting a digital format media to a streaming audio-video signal.

21. The apparatus of claim 13 further comprising:
the streaming audio-video server coupled in communication with the Internet for transferring a streaming audio-video signal to a selected one of the local media servers for play on a selected audio-video device.
